(19) United States
(12) Patent Application Publication
(10) Pub. No.: US 2009/0121467 A1
(43) Pub. Date: May 14, 2009

(54) ASSEMBLY FOR SUPPORTING GENERATORS ON TRUCK RIGS

(76) Inventors: James Oliver, Hohenwald, TN (US); Daniel Oliver, Linden, TN (US); Scott Oliver, Linden, TN (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(21) Appl. No.: 11/939,963

(22) Filed: Nov. 14, 2007

(51) Int. Cl. B60R 11/00

(52) U.S. Cl. 280/762; 248/637

(57) ABSTRACT

An assembly for attaching a generator to a truck chassis with members that define a generator support surface and distal ends with at least one that defines a first opening. An elongated member for each distal end with an opening has a first bearing surface and an offset second bearing surface and an opening. The elongated member is disposed with the first bearing surface contacting the distal end attachment portion and the second bearing surface contacting an interior surface of the flange of the C-beam. The fastener extending through the aligned openings rigidly attaches the members to the C-beam.

### TECHNICAL FIELD

The present invention relates to apparatus that mount on motor vehicles as supports for accessory equipment. More particularly, the present invention relates to assemblies and methods for attaching assemblies to truck rigs, which assemblies support supplemental generators on truck rigs.

### BACKGROUND OF THE INVENTION

Over the road diesel-powered tractor trailer rigs carry a significant amount of interstate transport of goods. Often, freight loads carried in the trailers are transported distances that require in excess of 8 to 10 hours travel time.

In an effort to reduce accidents, hours-of-service (HOS) rules were adapted to oversee driver operating time and rest time. In 1962, HOS rules allowed drivers to drive up to 10 hours after taking 8 hours off-duty. This however created a “day” as short as 18 hours and disrupted normal biological rhythms that re-occur at approximately 24 hour intervals. HOS rules adopted in 2005 provided for drive-time limit of 11 hours and prohibited drivers from driving beyond the 14^{th} hour after coming on duty following 10 consecutive hours off-duty. The HOS rules also included a 34 hour recovery provision and maximum on-duty hours after which a driver may not operate a commercial motor vehicle without recovery.

The effect of the hours of service regulations is to require solo drivers to stop driving for a significant period of time before resuming a long haul trip. To facilitate rest-stops, the travel trailer rigs were equipped with sleeper berths. Sleeper berths are separate cabins carried behind the cab and typically accessible through the cab. The sleeper berths allow the truck driver to rest in the truck at truck stops and rest areas on highways, rather than having to rent a room which adds to transportation costs. This also allowed trucks to continue moving by duel driver teams. Sleeper berths have developed into comfortable quarters that include HVAC, cooking devices such as microwave ovens, and entertainment such as radios and televisions, thereby providing a livable home center.

During these rest periods, truck drivers tend to idle the engine to provide heat or air conditioning, to keep the engine warm during extreme temperatures, to maintain adequate battery voltage while using electrical appliances, safety, and habit. A recent report estimates that approximately 500,000 trucks idle annually over 300 days per year. Trucks that use diesel fuel, idle the fuel away at the rate of 1 gallon per hour, which equals approximately 2,400 gallons per truck of fuel annually. Approximately 1.2 billion gallons of diesel fuel are consumed each year in the United States from idling of diesel trucks. Idling creates a cost of $1.8 billion (at a $1.50 per gallon) annually.

In addition to the cost of the consumed fuel, there are environmental effects. Every 28 hours in the United States, the same amount of fuel is idled away as was lost in a significant recent oil transportation disaster in Alaska (11 million gallons of crude oil spilled). Diesel exhaust contains small particulates, and such exhaust contributes to ozone formation (smog), and acid rain. Each idling truck emits over 21 tons of carbon dioxide (CO₂) and approximately 0.3 tons of nitrogen oxides (NO₂) annually, totaling over 11 million tons and 150 thousand tons respectively due to idling trucks. Diesel exhaust also contains sulfur dioxide, carbon monoxide, and hydrocarbons.

As an alternative to diesel truck idling, some truck stops provide electrical connections so that truckers can plug into commercial electrical service for about one-third of the cost of a gallon of diesel fuel typically consumed during an overnight rest period. Electrified truck stops eliminate the need for diesel trucks to idle during rest stops by providing grid-supplied electrical power through electrical outlets mounted on pedestals at the parking space. Drivers can connect their trucks to these electrical outlets at truck stops and rest areas, and receive the power needed to operate heating, air conditioning, and other electrical appliances such as televisions, microwaves and refrigerators.

As another alternative, some diesel trucks are provided with auxiliary power units. These are typically 5 to 10 horse-power generators that are installed on trucks and used for heat and air conditioning, electrical power and heat to the engine and fuel. The generators attach to structural beams of the frame of the tractor rig. The structural beams extend longitudinally rearwardly of the cab of the truck. Typically, the structural beams are C-shaped steal members disposed in opposing relation. Often however this space behind the cab is crowded, and includes the coupler assembly for connecting or hitching the travel trailers to be pulled by the tractor rig, as well as tool boxes, fuel tanks, HVAC equipment, and other equipment. Often the generator mounts by cantilever attachment to the side face of one of the support members. This may displace a tool box, so the change is not without some adjustment. To attach the generator as a cantilever to the structural beam however often requires drilling holes through the side face of the structural member. Bolts extend through the openings and connect to the generator frame. This often is not satisfactory, as some manufacturers caution against drilling or modifying the structural members of the travel trailer rig.

Accordingly, there is a need in the art for an assembly that readily installs on truck rigs for supporting generators that provide power to the truck during rest stops. It is to such that the present invention is directed.

### SUMMARY OF THE INVENTION

The present invention meets the need in the art by providing an assembly for readily attaching a generator to a structural C-beam of a truck chassis. The assembly includes member means that defines a generator support surface and has opposing distal end attachment portions, with at least one distal end portion that defines a first opening therein. At least a pair of elongated members for attaching a respective distal end attachment portion of the member means to a respective flange of a C-beam of a truck chassis. Each elongated member defines a first bearing surface and a second bearing surface offset from the first bearing surface and an opening therethrough. A fastener for each elongated member extends through the aligned opening in the elongated member and in the opening in the respective distal end attachment portion. The elongated members for being disposed with the first bearing surface contacting the respective distal end attachment portion and the second bearing surface contacting an interior surface of the flange of the C-beam with the fastener extending through the aligned openings in the elongated member and the distal end attachment portion for rigidly attaching the member means to the C-beam.

Objects, features, and advantages of the present invention will become readily apparent upon reading of the following detailed description in conjunction with the drawings and the appended claims.

### BRIEF DESCRIPTION OF THE DRAWINGS

FIG. 1 illustrates in perspective view a truck rig having an assembly of a type according to the present invention that supports a generator as an auxiliary accessory that provides electrical power to the truck rig during rest periods and other non-driving operation of the truck rig.

FIG. 2 illustrates in perspective exploded view a first embodiment of an assembly that supports a generator on a truck rig.

FIG. 3 illustrates in detailed perspective view a mounting plate and fastener for securing the assembly shown in FIG. 2 to a flange of a structural beam in a truck rig chassis.

FIG. 4 illustrates in detailed perspective view a slot of the assembly shown in FIG. 2 engaging a flange of a C-beam of a truck rig.

FIG. 5 illustrates in detailed view the bracket assembly shown in FIG. 2 mounted to opposing C-beams of a truck rig with a generator exploded away.

FIG. 6 illustrates in perspective view a second embodiment of the assembly that supports a generator on a truck rig.

FIG. 7 illustrates in perspective view a third embodiment of the assembly that supports a generator on a truck rig.

FIG. 8 illustrates in perspective view a first bracket of the third embodiment of the assembly attached to the C-beam of a truck rig and a second bracket thereof in an installation position relative to the C-beam, for cooperatively supporting a generator.

### DETAILED DESCRIPTION

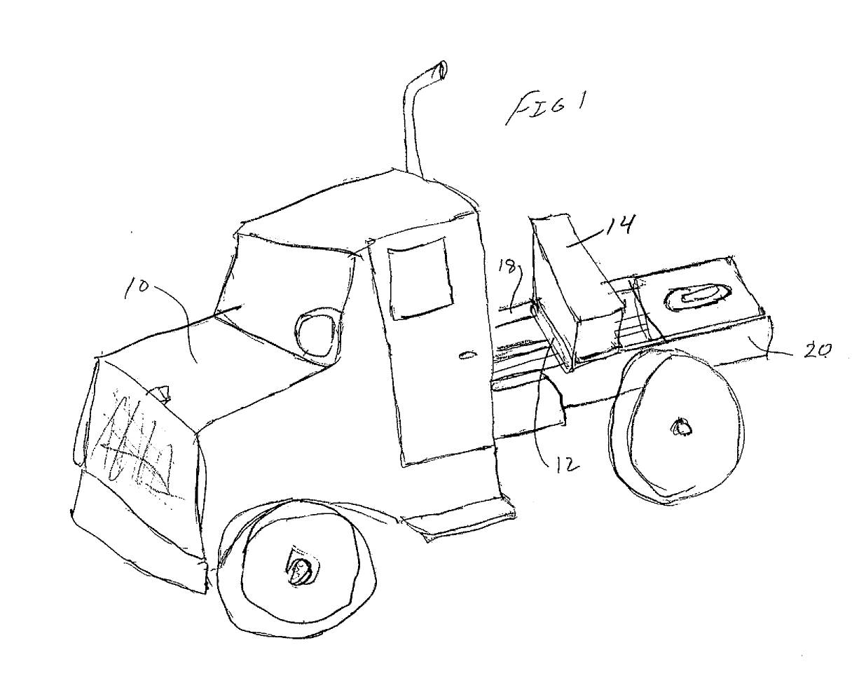

With reference to the drawings in which like reference numerals indicate like parts, FIG. 1 illustrates in perspective view a diesel truck rig 10 having an accessory support assembly generally 12 of a type according to the present invention that supports a generator 14 as an auxiliary accessory that provides electrical power to the truck rig for powering lights, HVAC (heat ventilation and air conditioning), and other equipment including television, refrigerators, and microwave ovens, during rest stops and other non-driving operation of the truck rig. The support assembly 12 provides mounting brackets that attach to opposing C-beams 18, 20 of the truck rig rearwardly of the cab generally 22.

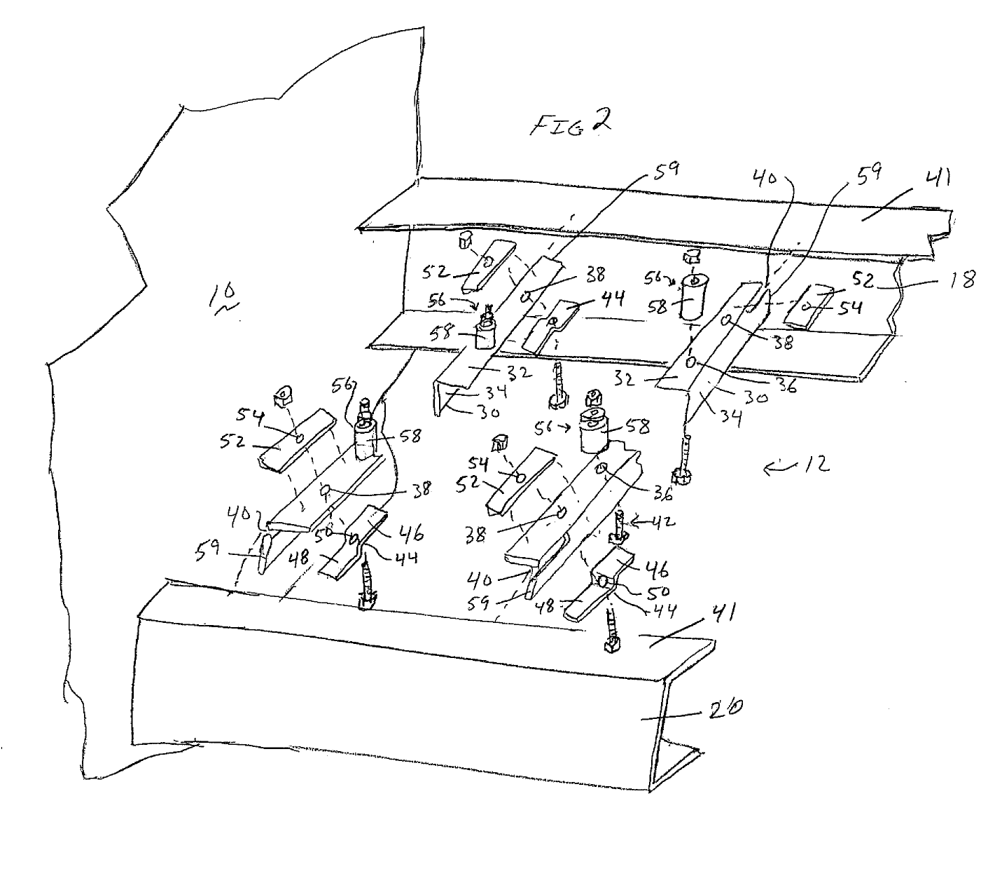

FIG. 2 illustrates in perspective exploded view of a first embodiment of the assembly 12 that provides a readily attached structure for supporting accessories, such as a generator, on the opposing C-beams 18, 20 of the truck chassis. The assembly 12 includes a pair of angle members 30 disposed in spaced-apart relation. Each angle member defines a support surface 32 and an angularly extending strengthening rib 34. The support surface 32 defines a pair of spaced-apart first openings 36 and a pair of spaced-apart second openings 38. The second openings 38 are defined in a respective distal end outwardly of the adjacent first opening 36. Each angle member 30 defines a slot 40 in each opposing end. The slots 40 extend longitudinally from a respective distal end towards the opposing distal end of the angle member 30. The slots 40 slidably receive a portion of the flange 41 of the C-beam 18 or 20 of the truck chassis, as discussed below, for use of the assembly 12 to support accessories such as the generator. Fasteners 42, such as a bolt, washer, and nut connect with the bolt extending through the first openings, for connecting an accessory, for example, a generator, to the angle members 30.

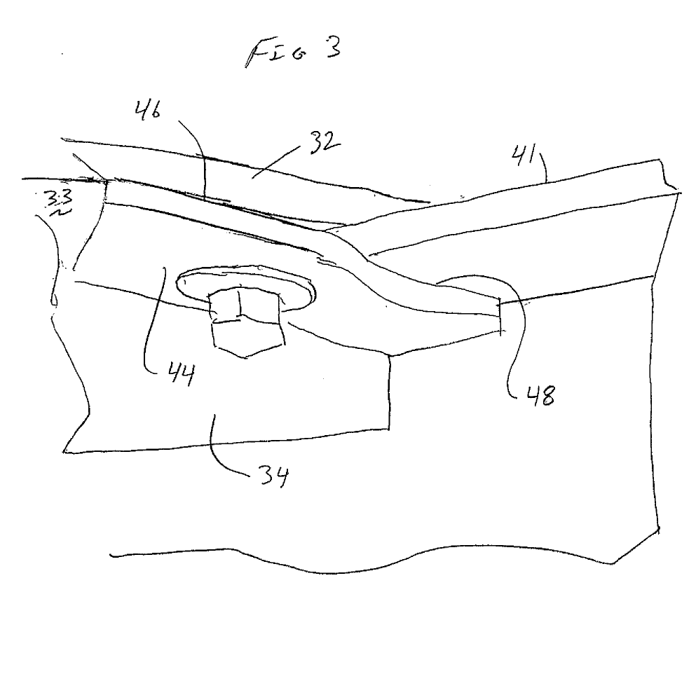

The assembly 12 includes a pair of elongated members 44 that cooperatively secure the angle member 30 to the C-beam. Each elongated member 12 defines a first bearing surface 46 and a second bearing surface 48. The second bearing surface 48 is offset from the first bearing surface 46. The elongated member 44 also defines an opening 50. A fastener, such as a bolt, extends though the opening 50 in the elongated member 44 and through an aligned one of the second openings 38 in the angle member 30. As best illustrated in FIG. 3, the elongated members 44 are disposed with the first bearing surface 46 contacting the opposing side 33 of the support surface 32, and the second bearing surface 48 contacting an interior surface of the flange 41 of the C-beam, with the fastener extending through the opening 50 that is aligned with a respective second opening 38 in the angle member 30 for rigidly attaching the angle member to the C-beam.

In the illustrated embodiment, the elongated member 44 in side view defines an elongated S-shape member. The bearing surfaces 46, 48 are offset. In the illustrated embodiment, the elongate member is a steel plate that has been pressed to define the S-shape with the offset bearing surfaces. In an alternate embodiment, the elongated member is a machined part having stepped offset bearing surfaces 46, 48.

With continuing reference to FIG. 2, the assembly 12 further includes selectively a pair of bearing plates 52. Each plate 52 defines an opening 54 for alignment with one of the second openings 38 in the angle member 30. The plates 52 are received on the support surface with the opening 52 aligned with a respective one of the second openings 38 for receiving a portion of the fastener therethrough. The fasteners each comprise threaded bolts, washers, and nuts for fastening the angle members to the C-beam.

In the illustrated embodiment, a generator mount generally 56 comprises a threaded bolt, washers, a nut, and a resilient bushing member 58 received on the bolt for cushioningly supporting a generator.

A distal end edge 59 of the angle member 30 abuttingly contacts an inner surface of a web portion of the C-beam.

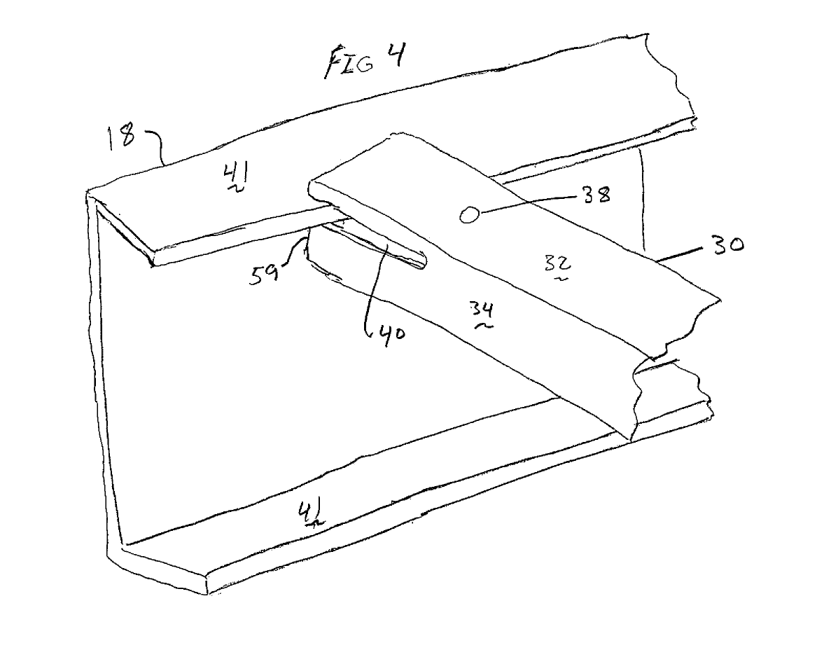

FIG. 4 illustrates in detailed perspective view the slot 40 of the angle member 30 shown in FIG. 2 engaging the flange 41 of the C-beam 16, 18 of the truck rig. This is accomplished by orienting the member 30 at an oblique angle to the opposing flanges 41, sliding the free edge of the flanges 41 into the slots 40, and then moving the member 30 into a perpendicular orientation relative to the flanges 41. The edges of flanges 41 slide along the slots 40. The distal edges 59 of the angle members preferably abuttingly contact the inner surface of the web portion of the C-beam.

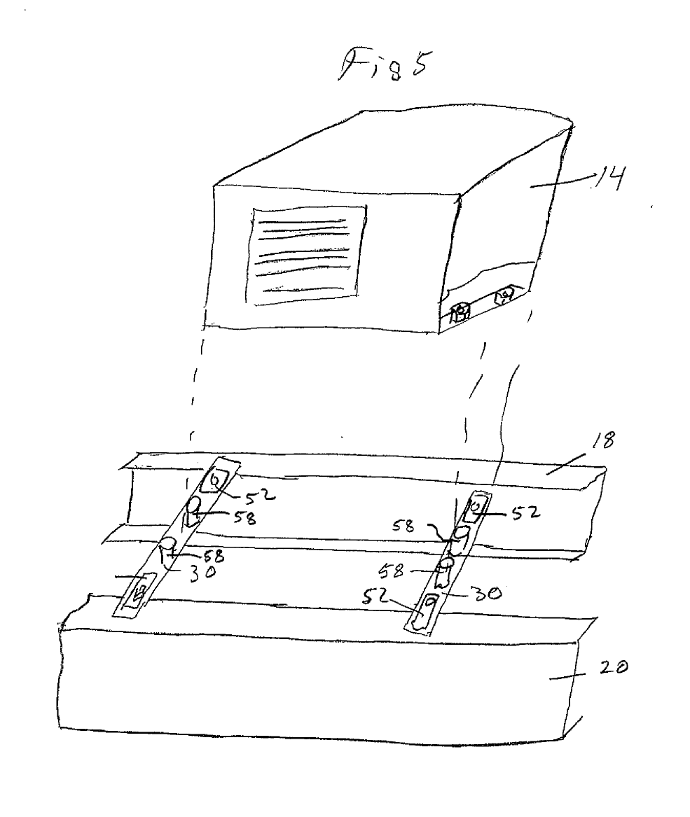

FIG. 5 illustrates in detailed view the bracket assembly 12 shown in FIG. 2 mounted to opposing C-beams 18, 20 of the truck rig 10 with the generator 14 exploded away.

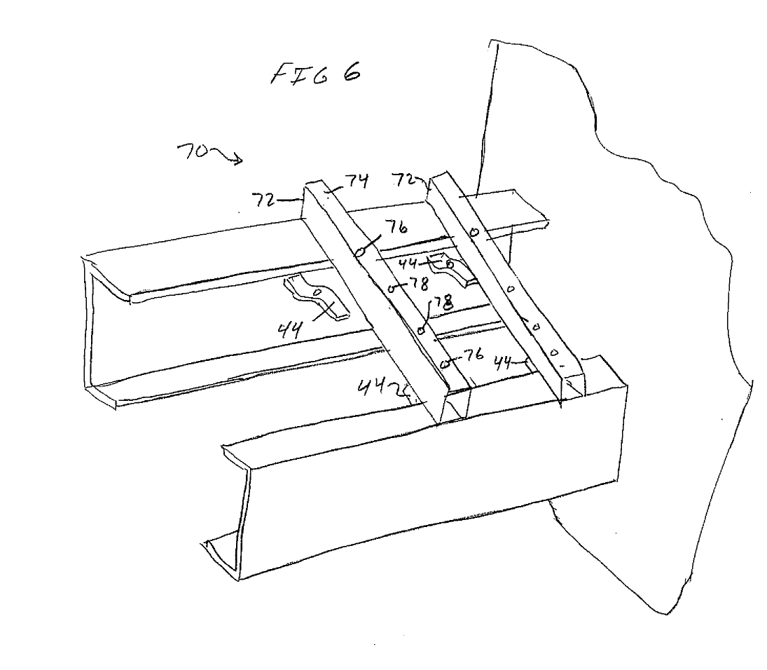

FIG. 6 illustrates in perspective view a second embodiment 70 of the assembly that supports the generator 14 on the truck rig 10. The assembly of the second embodiment 70 provides for mountingly attaching the generator 14 to flange portions 41 of the opposing C-beams of the truck chassis 10. The assembly includes a pair of elongate tubular members 72. Each tubular member 72 defines a generator support surface 74 and a pair of spaced-apart first openings 76 that receive fasteners to rigidly connect the generator 14 to the member 72. A pair of the elongated members 44 cooperatively secure the opposing ends of the tubular member 72 to the opposing flanges 41 of the C-beams. As discussed above, each elongated member 44 defines the first bearing surface 46 and the second bearing surface 48 offset from the first bearing surface 48 as well as the opening 50.

The tubular member 72 further defines second openings 78 in distal end portions. A fastener 80 extends through the opening 50 of a respective one of the elongate members 44 and an aligned one of the first openings 76 in order to attach the tubular member 72 to the flange 41 of the C-beam of the truck chassis 10. The elongated members 44 disposed with the first bearing surface 46 contacting a side of the tubular member opposing the generator support surface and the second bearing surface 48 contacting an interior surface of the flange of the C-beam. The fasteners extend through the opening 50 in the elongated member that is aligned with the first opening of the tubular member 72 for rigidly attaching the tubular member to the C-beam.

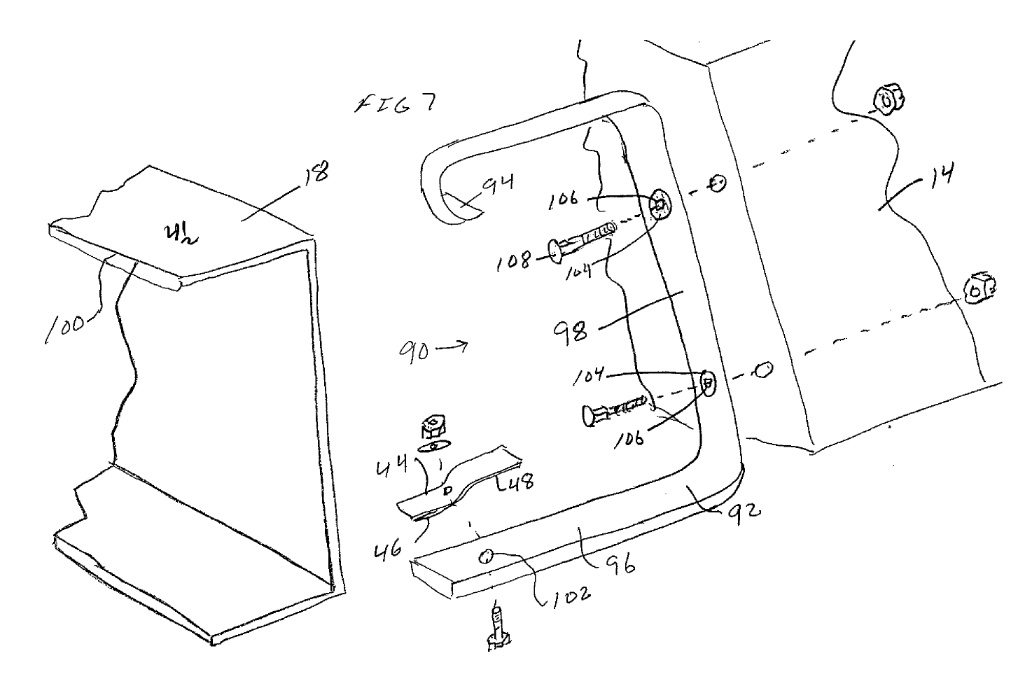

FIG. 7 illustrates in perspective view a third embodiment 90 of the assembly that supports a generator on a truck rig. 10. The assembly 90 provides for cantilever mounting of the generator 14 to the flanges 41 of one of the pair of opposing C-beams 18, 20 of the truck chassis. The assembly 90 includes a pair of mounts 92. Each mount 92 comprises an elongated gripping member defining generally a C-shape. The mount includes a hook 94 at a first distal end and an arm portion 96 extending from a web portion 98. The hook 94 is configured to overlap a distal or free edge 100 of the flange 41 of the C-beam 18 of the truck chassis. The arm portion 96 defines an opening 102. The web portion 98 defines recesses 104, such as formed by stamping, and openings 106 for receiving fasteners for connecting to the generator 14. The recesses are sufficiently deep to hold a head of a bolt 108 with the face of the web portion 98 substantially in contact with the outside surface of the C-beam 18. The opening 106 can be rectangular, so that the fastener can be a carriage bolt having a rectangular shank adjacent the head. This facilitates attaching a nut to the threaded shank of the fastener that extends inwardly of the generator for securing the generator 14 cantilevered to the mount 92 and thus to the C-beam.

One of the elongated members 44 is provided for each mount 92 to cooperatively secure the mount to the C-beam, as discussed below. A fastener extends through the opening 50 in the elongated member 44 and the aligned opening 106 in the arm portion 96. The elongated member 44 is disposed with the first bearing surface 46 contacting the arm portion 96 of the mount 92 and the second bearing surface 48 contacting an interior surface of a second flange 41 of the C-beam, The fastener extend through the opening 50 aligned with the opening 106 in the arm portion 96. The hook 94 contactingly engages to the free edge of the opposing first flange, for rigidly attaching the mount 92 to the C-beam. At least a pair of the mounts are used to attach the generator 14 to the side of the C-beam.

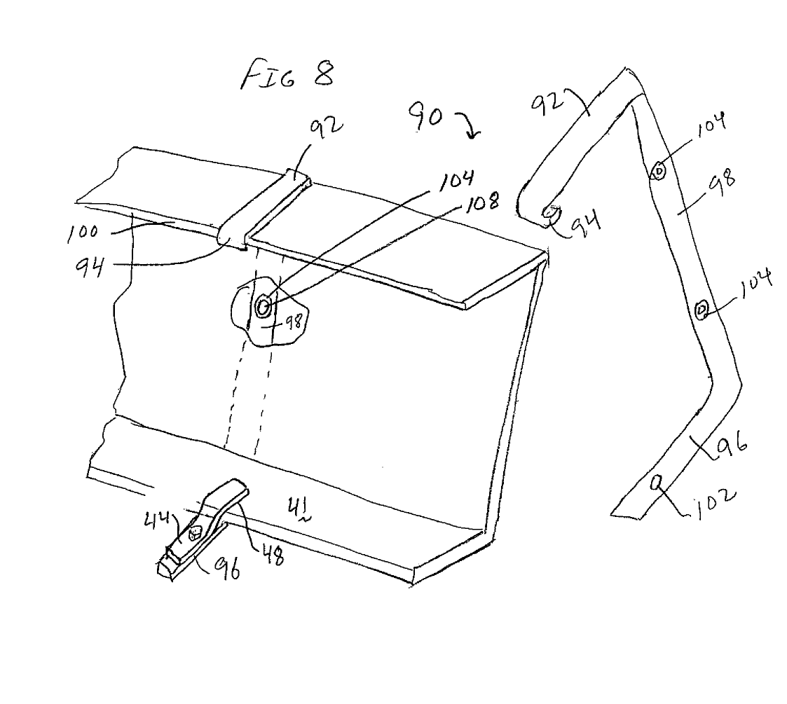

FIG. 8 illustrates in perspective view a first mount 92 of the third embodiment of the assembly attached to the C-beam 18 of the truck rig and a second mount in an installation position relative to the C-beam, for cooperatively supporting the generator 14. The fasteners are positioned with the heads in the recesses and threaded stems extending outwardly. The hook 94 catches on the free edge of the flange 41, and the mount 92 is pivoted towards the C-beam 18 to move the arm portion 96 under and laterally of the opposing flange of the C-beam. The elongate member 44 is attached, with the bearing surfaced 46 in contact with the arm portion 96 and the bearing surface 48 in contact with the inner surface of the flange 41. The fastener extends through the aligned openings 50 and 106 and is secured with a nut to rigidly connect the mount 92 to the C-beam. Another of the mounts 92 is similarly attached. The generator 14 connects to the threaded shafts extending from the mounts 92.

The foregoing specification describes various embodiments of the present invention that provides an assembly readily installed on truck rigs for supporting accessories including generators that provide power to the truck rig during rest periods and other non-driving operations involving the track rig and a need for electrical power to the truck rig and methods of attaching such assemblies to truck rigs. It is to be understood, however, that numerous changes and variations may be made in the construction of the brackets for mounting generators to truck rigs within the spirit and scope of the present invention and that modifications and changes may be made therein without departing from the scope thereof as set forth in the appended claims.

What is claimed is:

1. An assembly for attaching a generator to structural C-beams of a truck chassis, comprising:
member means defining a generator support surface and having distal end attachment portions with at least one distal end portion that defines a first opening therein;
at least a pair of elongated members, each for attaching a respective distal end attachment portion of the member means to a flange of one of a pair of opposing C-beams of a truck chassis, each elongated member defining a first bearing surface and a second bearing surface offset from the first bearing surface and an opening therethrough;
a fastener for each elongated member for extending through the opening in a respective one of the elongated members and an aligned one of the first openings in the distal end attachment portion,
the elongated members for being disposed with the first bearing surface contacting the distal end attachment portion and the second bearing surface contacting an interior surface of the flange of the C-beam with the fastener extending through the aligned openings in the elongated member and the distal end attachment portion for rigidly attaching the member means to the C-beam.

2. The assembly as recited in claim 1, wherein member means comprises a pair of angle members, each defining a portion of the generator support surface and an angularly extending strengthening rib, the portion of the generator support surface defining a pair of spaced apart second openings and the attachment distal end portion defined by distal end portions of the angle members, each angle member defining a slot in each opposing end thereof, each slot extending longitudinally from the respective distal end towards the opposing distal end, the slots for slidably receiving a portion of the flange of a C-beam of a truck chassis.

3. The assembly as recited in claim 2, further comprising generator mount fasteners extending through the first openings for connecting a generator to the angle members.

4. The assembly as recited in claim 3, wherein the generator mount fasteners comprise a threaded bolt, washers, a nut, and a resilient bushing member received on the bolt for cushioningly supporting a generator.

5. The assembly as recited in claim 1, wherein member means comprises a pair of elongate tubular members, each having a portion of the generator support surface and defining a pair of spaced apart second openings, and the attachment distal end portion defined by distal end portions of the tubular members.

6. The assembly as recited in claim 1, wherein member means comprises a pair of mounts, each mount comprising a pair of gripping members, each gripping member defines generally a C-shape member having a hook at a first distal end and an arm portion extending from a web portion thereof, the arm portion defining the attachment distal end portion and the hook configured to overlap an edge of a first flange of a C-beam of a truck chassis.

7. The assembly as recited in claim 1, wherein each elongated member in side view defines a generally elongated S-shape member.

8. The assembly as recited in claim 1, wherein the fasteners each comprise threaded bolts, washers, and nuts for fastening the member means to the C-beam.

9. A generator mount for attaching a generator to flange portions of a pair of opposing C-beams of a truck chassis, comprising:
a pair of angle members, each having a generator support surface and an angularly extending strengthening rib, the generator support surface defining a pair of spaced apart first openings and a pair of second openings, each of the second openings in a respective distal end outwardly of the adjacent first opening;
each angle member defining a slot in each opposing end thereof, each slot extending longitudinally from a respective distal end towards the opposing distal end, the slots for slidably receiving a portion of the flange of a C-beam of a truck chassis;
generator mount fasteners extending through the first openings for connecting a generator to the angle members;
a pair of elongated members for each angle member, each elongated member defining a first bearing surface and a second bearing surface offset from the first bearing surface and an opening therethrough;
a pair of fasteners for each angle member, each fastener extending through a respective one of the openings in the elongated members and an aligned one of the second openings,
the elongated members for being disposed with the first bearing surface contacting an opposing side of the generator support surface and the second bearing surface contacting an interior surface of the flange of the C-beam with the fasteners extending through the opening therein aligned with a respective second opening in the angle member for rigidly attaching the angle member to the C-beam.

10. The generator mount as recited in claim 9, wherein each elongated member in side view defines an elongated S-shape member.

11. The generator mount as recited in claim 9, further comprising a pair of bearing plates, each defining an opening therethrough and disposed on the generator support surface with a respective one of the second openings for receiving a portion of the fastener therethrough.

12. The generator mount as recited in claim 9, wherein the fasteners each comprise threaded bolts, washers, and nuts for fastening the angle members to the C-beam.

13. The generator mount as recited in claim 9, wherein the generator mount fasteners comprise a threaded bolt, washers, a nut, and a resilient bushing member received on the bolt for cushioningly supporting a generator.

14. The generator mount as recited in claim 9, wherein a distal end edge of the angle member abuttingly contacts an inner surface of a web portion of the C-beam.

15. A generator mount for attaching a generator to flange portions of a pair of opposing C-beams of a truck chassis, comprising:
a pair of elongate tubular members, each having a generator support surface and defining a pair of spaced-apart first openings;
a pair of elongated members for each tubular member, each elongated member defining a first bearing surface and a second bearing surface offset from the first bearing surface and a second opening therethrough;
a pair of fasteners, each for extending through the second opening of a respective one of the elongate members and an aligned one of the first openings in order to attach the tubular member to a flange of a C-beam of a truck chassis,
whereby the elongated members disposed with the first bearing surface contacting a side of the tubular member opposing the generator support surface and the second bearing surface contacting an interior surface of the flange of the C-beam with the fasteners extending through the second opening therein aligned with the first opening of a respective one of the tubular members for rigidly attaching the tubular member to the C-beam.

16. The generator mount as recited in claim 15, wherein each elongated member in side view defines an elongated S-shape member.

17. The generator mount as recited in claim 15, wherein the fasteners each comprise threaded bolts, washers, and nuts for fastening the tubular members to the C-beam.

18. The generator mount as recited in claim 15, further comprising generator mount fasteners for securing a generator to the tubular members.

19. The generator mount as recited in claim 18, comprise a threaded bolt, washers, a nut, and a resilient bushing member received on the bolt for cushioningly supporting a generator.

20. A generator mount for attaching a generator to opposing C-beams of a truck chassis, comprising:
a pair of mounts, each mount comprising a pair of gripping members, each gripping member defines generally a C-shape member having a hook at a first distal end and an arm portion extending from a web portion thereof, the arm portion defining an opening therein and the hook configured to overlap an edge of a first flange of a C-beam of a truck chassis;
an elongated member for each gripping member, each elongated member defining a first bearing surface and a second bearing surface offset from the first bearing surface and an opening therethrough;
a fastener for each elongated member, each fastener extending through the opening in the elongated member and the aligned opening in the arm portion,
the elongated member for being disposed with the first bearing surface contacting the arm portion of the gripping member and the second bearing surface contacting an interior surface of a second flange of the C-beam with the fastener extending through the opening therein aligned with the opening in the arm portion and the hook contactingly engaged to an edge of the opposing first flange, for rigidly attaching the gripping member to the C-beam.

21. The generator mount as recited in claim 20, wherein each elongated member in side view defines a generally elongated S-shape member.

22. The generator mount as recited in claim 20, wherein the fasteners each comprise threaded bolts, washers, and nuts for fastening the gripping members to the C-beam.

23. The generator mount as recited in claim 20, wherein the generator mount fasteners comprise a threaded bolt, washers, a nut, and a resilient bushing member received on the bolt for cushioningly supporting a generator.
